(19) United States
(12) Patent Application Publication
(10) Pub. No.: US 2015/0083443 A1
(43) Pub. Date: Mar. 26, 2015

(54) METHOD OF PROTECTING A STRUCTURE FROM A FIRE

(71) Applicant: Mark Thompson, Midland, MI (US)

(72) Inventor: Mark Thompson, Midland, MI (US)

(21) Appl. No.: 14/036,357

(22) Filed: Sep. 25, 2013

(51) Int. Cl. A62C 2/10

(52) U.S. Cl. CPC A62C 2/10
USPC 169/45

(57) ABSTRACT

A method of protecting a structure from a fire. The method comprises covering the structure with a fire-retardant liquid absorbent material and spraying fire-retardant liquid on the fire-retardant liquid absorbent material. In a second embodiment, there is a method wherein the fire-retardant liquid absorbent material is draped over with a high temperature insulation material in segments forming seams, after the fire-retardant liquid absorbent material is sprayed. A third method comprises layering a structure with a high temperature insulation material and then layering said high temperature insulation layer with a liquid absorbing layer.

### BACKGROUND OF THE INVENTION

The inventor is unaware of any prior art relative to this invention.

### THE INVENTION

Thus, what is disclosed and claimed herein in one embodiment is a method of protecting a structure from a fire. The method comprises covering the structure with a liquid absorbent material and spraying a fire retardant liquid on the liquid absorbent material.

In a second embodiment, there is a method as set forth just Supra, wherein in addition, the fire-retardant liquid absorbent material is draped over with a high temperature insulation material in segments forming seams after the fire-retardant liquid absorbent material is sprayed.

In yet another embodiment, there is a method as set forth just Supra wherein the high temperature insulation material has a foil facing on one side.

Finally, in a last embodiment, there is a method wherein the high temperature insulation material is a composite.

Water is the preferred fire retardant liquid material for purposes of this invention.

### BRIEF DESCRIPTION OF THE DRAWINGS

FIG. 1 is a full view in perspective of one kind of structure showing a first cover of a plastic liquid barrier.

FIG. 2 is a full view in perspective of the structure of FIG. 1 wherein there is shown a portion of a first covering of fire-retardant liquid absorbent material.

FIG. 3 is a full view in perspective of the structure of FIG. 2 wherein there is shown a portion of a high temperature insulating material covering a portion of the fire-retardant liquid absorbent material.

FIG. 4 is a full view in perspective of the structure of FIG. 3 wherein the high temperature insulating cover shows excess draping over the structure.

FIG. 5 is a schematic of the individual layers of the invention.

FIG. 6 is a schematic of the individual layers of the invention in reverse order of application.

### DETAILED DESCRIPTION OF THE INVENTION

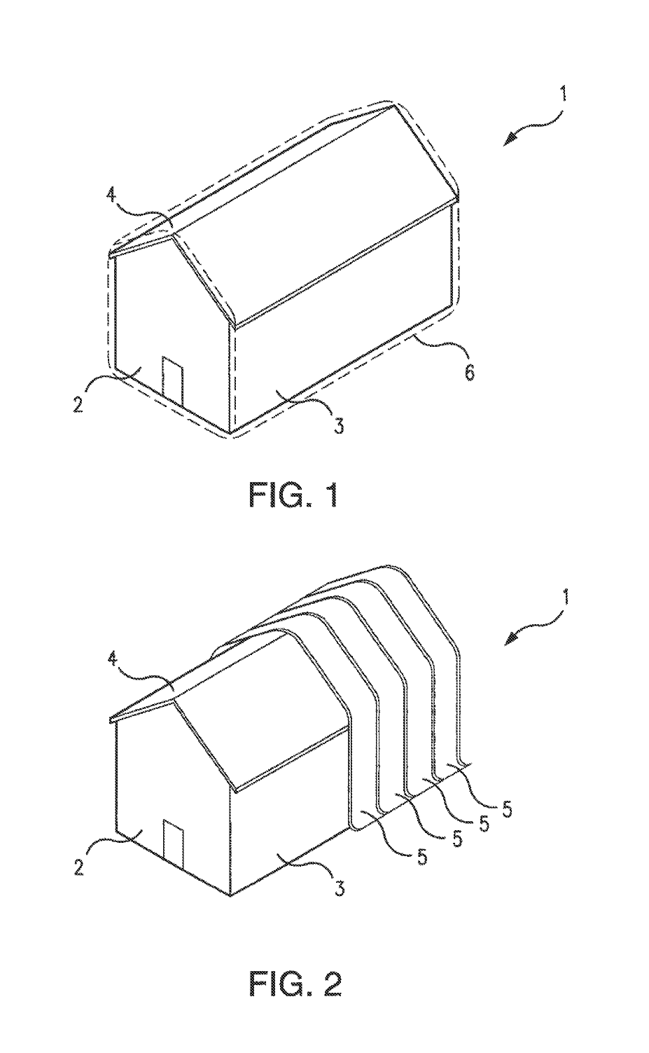

Turning now to FIG. 1, there is shown a schematic drawing of a typical structure 1 intended to be protected from fire, especially a forest fire. Typically, in forest fires, the structure to be protected is a residence.

There is shown a front 2, one side 3, and a roof 4. As shown in FIG. 2, there is a draped covering of fire-retardant liquid absorbent material 5. The fire-retardant liquid absorbent material 5 can be put on in drapery style, like a quilt, or can be sprayed. on similar to hydro seeding. A useful fire-retardant liquid absorbent material 5 can be purchased as DRYTECH® sold by the Dow Chemical Company, Midland, Mich. This material is a liquid absorbent material comprised of synthetic polymers. It is especially useful in absorbing large quantities of fire-retardant liquid.

In this specification and drawings, even though a “portion” of the coverings is shown, it is intended within the scope of this invention to completely cover the structure. In fact, it may be preferable to cut or remove any protrusions from the structure, such as porches or garages, or, cover the porch or garage as a means of protecting “the entire structure”. In emergencies, it is often quite preferable to protect only the major structure with the sacrifice of any protuberances such as garages or porches, or the like.

The first embodiment of this invention comprises the covering of a structure with fire-retardant liquid absorbent material 5 and then spraying it with fire-retardant liquid. This manner of coverage will protect a structure, but only for a short period of time.

In the use of the fire-retardant liquid absorbent material 5, it is useful to first cover the structure with a plastic liquid barrier 6 to protect the structure from excess fire-retardant liquid damage and to aid in clean-up of the structure after the fire.

As shown in FIG. 2, a portion of the structure 1 is covered with a blanket 5 of fire-retardant liquid absorbent material (no plastic liquid barrier is shown in order to clarify the drawing). Even though the fire-retardant liquid absorbent material is shown as a blanket in FIG. 2, it should be remembered and understood that this covering 5 can also be sprayed on the structure. Also contemplated within the scope of this invention is the use of a wire mesh 11 over top of the fire-retardant liquid absorbent layer 5 for support of the fire-retardant liquid absorbent layer 5. In addition, it is contemplated within the scope of this invention to place an additional layer of fire-retardant liquid absorbent material over the wire mesh 11.

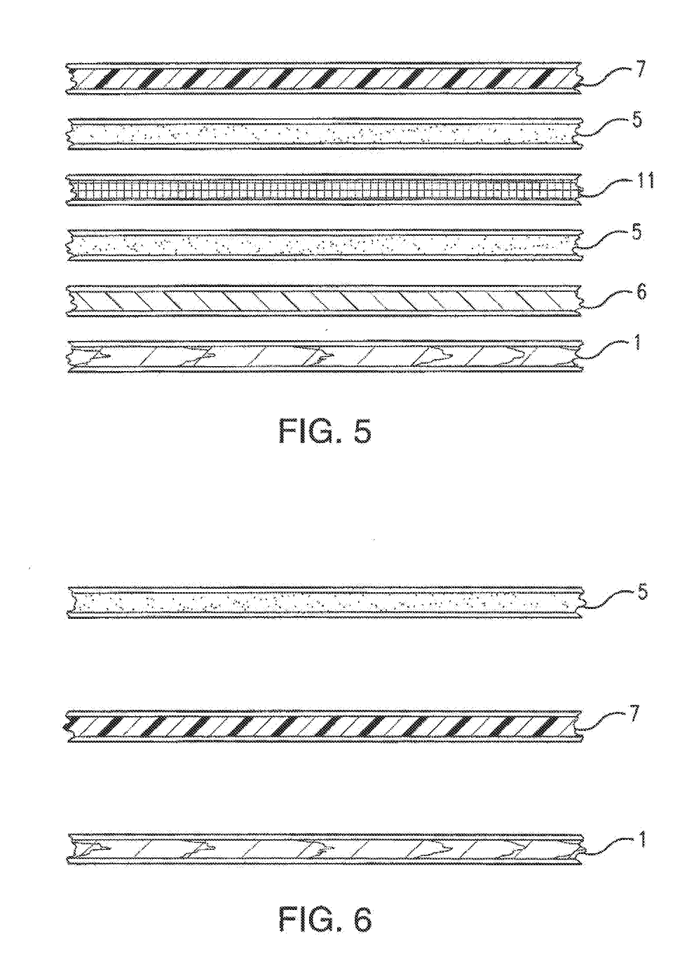

FIG. 5 shows this arrangement wherein there is shown the base structure 1, overlaid with a liquid barrier layer 6, overlaid with a fire-retardant liquid absorbent layer 5, overlaid with a wire mesh 11, overlaid with a fire-retardant liquid absorbent layer 5, and overlaid with a high temperature insulating material 7. The layers are separated for clarity purposes.

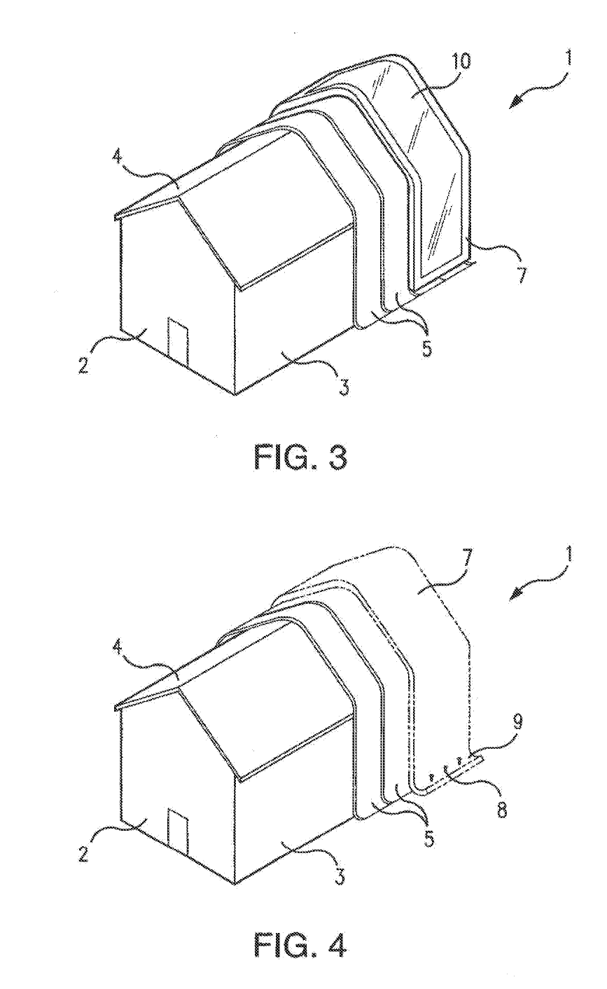

Turning now to the use of a high temperature insulating material 7, as shown in FIG. 3, only a portion of such a cover is shown. A dotted line is shown for clarity. This covering is a fire retardant cover with interior insulative material as is normally used in insulating incinerators, heat exchangers, gasifiers, and the like.

These materials are normally formed into blankets or cohesive coverings and attached to the device being insulated. Another mode of using these materials is to use strips of the insulating material 7 and attaching the strips to the structures and then fastening the strips together using staples and the like. Typically, as in other end uses for high temperature insulating material, the edges of the strips are folded over and then stapled. It is contemplated within the scope of this invention for the high temperature insulating materials to be composites.

Care should be taken to not have overlapping seams between the fire-retardant liquid absorbent blanket 5 type layers and the high temperature insulating layers 7 so as to prevent a possible breach in the covering with regard to protection from fire.

It is contemplated within the scope of this invention to use a high temperature insulating material 7 having a metallic foil 10 on the outside surface so as to reflect heat (See. FIG. 3).

FIG. 4 shows a high temperature insulating material 7 that has excess material 9 overhanging the side 3 of the structure 1 (shown in dotted lines to clarify the drawing). The need for this excess 9 is for fastening or securing the high. temperature insulating material 7 to the ground. This can be accomplished by using stakes 8, spring loaded fasteners, heavy weights, and the like.

What is claimed is:

1. A method of protecting a structure from a fire, said method comprising:
a. covering said structure with a fire retardant liquid absorbent material, and,
b. spraying a fire retardant liquid on said fire retardant liquid absorbent material.

2. A method as claimed in claim 1 wherein in addition, said fire-retardant liquid absorbent material is draped with a high temperature insulation material in segments forming seams, after said fire-retardant liquid absorbent material is sprayed.

3. A method as claimed in claim 2 wherein said high temperature insulation material has a foil facing on one side.

4. A method as claimed in claim 2 wherein said high temperature insulation material is a composite.

5. A method as claimed in claim 2 wherein said seams are secured.

6. A method as claimed in claim 2 wherein said high temperature insulating material covers said entire said structure and has excess to lay on any ground adjacent to said structure.

7. A method as claimed in claim 6 wherein said excess high temperature insulating material is secured to said ground.

8. A method of protecting a structure from a fire as claimed in claim 1 wherein said structure is first covered with a liquid repellent cover prior to covering with said fire-retardant liquid absorbent material.

9. A method as claimed in 1 wherein a wire mesh covers said fire retardant liquid absorbent material.

10. A method as claimed in claim 9 wherein said wire mesh is covered with an additional layer of fire-retardant liquid absorbent material.

11. A method as claimed in claim 2 wherein any seams of high temperature insulating material are secured together.

12. A method of protecting a structure from fire, said method comprising draping said structure with a high temperature insulation material and thereafter, applying a layer of fire-retardant liquid absorbent material;
thereafter, spraying with fire-retardant liquid.
